(19) United States
(12) Patent Application Publication
(10) Pub. No.: US 2009/0190434 A1
(43) Pub. Date: Jul. 30, 2009

(54) STRAIGHT THROUGH CEMENT MIXER

(76) Inventor: THOMAS E. ALLEN, Tulsa, OK (US)

Correspondence Address: Molly D McKay, P.C., 2301 S Sheridan-Suite A, Tulsa, OK, 74129, US

(21) Appl. No.: 12/021,415

(22) Filed: Jan. 29, 2008

(51) Int. Cl. B01F 15/02; B01F 15/04

(52) U.S. Cl. 366/132; 366/135; 366/136; 366/137

(57) ABSTRACT

A cement mixing method for mixing cement used in cementing oil wells casing and the mixer used in that method. The mixer employs a straight bulk cement inlet, five annular recirculation jet and five annular water jet orifices located downstream of the recirculation jets so that all of the jets discharge at an angle towards the mixing chamber. The five annular recirculation jets are located in alternating longitudinal alignment within the mixing chamber relative to the five annular water jets. This five jet, intersecting flow design allows for more thorough wetting of the cement powder with a smaller, lighter, less expensive and more durable mixer that is less inclined to foul and easier to clean.

### CROSS REFERENCE TO RELATED APPLICATIONS

Applicant is the sole inventor of U.S. Pat. No. 6,749,330 that issued on Jun. 15, 2004 for Cement Mixing System for Oil Well Cementing. Applicant is also one if the co-inventors of U.S. Pat. No. 5,046,855 that issued on Sep. 10, 1991 for Mixing Apparatus; one of the co-inventors of U.S. Pat. No. 5,355,951 that issued on Oct. 18, 1994 for Method of Evaluating Oil or Gas Well Fluid Process; and the sole inventor of U.S. Pat. No. 5,571,281 that issue on Nov. 5, 1996 for Automatic Cement Mixing and Density Simulator and Control System and Equipment for Oil Well Cementing.

### BACKGROUND OF THE INVENTION

1. Field of the Invention

The present invention is a high efficiency, high energy slurry mixer used primarily to mix oil field cement in a recirculating system for cementing the casing in oil and gas wells. The cement mixer mixes dry powder with water and recirculated slurry to create the cement mixture. The cement mixer employs a straight through design that that is easier to wash up than previous designs and which can be seen straight through when the connection at the dry powder inlet is removed from the mixer. The cement mixer also has increased number and volume of alternating annular water flow openings and recirculation openings which allows for more water and slurry flow with less erosion to the mixer surface than previous designs. The previous design did not allow for more recirculation and water jets because there was not room to add them. The new design allows the mixer surfaces to be manufactured with lesser expensive materials without sacrificing performance and life, thereby reducing the cost of the equipment by approximately half. The present design eliminates most of the wear problems experienced in earlier designs resulting in the equipment lasting longer before repair or replacement is required.

2. Description of the Related Art

The discussion regarding related art appearing in U.S. Pat. No. 6,749,330 is hereby included by reference. The cement mixer design taught in U.S. Pat. No. 6,749,330 had several problems. First, the earlier mixer was not of a straight through type. That earlier mixer included 1^{st} and 2^{nd} elbows (associated with reference numerals 114 and 116 in the patent) in the central recirculation line 54, and included a curved inlet 52 for the dry bulk cement. Because of this design, it was more difficult to flush out and clean the inside of the mixer. Also, it was not possible to see straight through the mixer by breaking open the piping connection at the inlet 52, thus making it more difficult to see inside the mixer to troubleshoot or determine if it was clean when doing maintenance.

Further, the central recirculation line of that earlier mixer was just one additional surface which could be eroded by the abrasive recirculated cement slurry contained within its interior.

Also, the four annular water jets of the earlier mixer had less flow capacity, resulting in higher velocity of liquid streams within the mix chamber to obtain comparable flow rates and thus more erosion of the interior mixer surfaces due to the abrasion caused by the abrasive sand in dirty mix water. Additionally, the earlier mixer employed a somewhat complicated design having multiple passageways, all of which are susceptible to erosion by the dirty mix water. This erosion caused the earlier mixer to have erosion problems resulting in more equipment maintenance and shorter equipment life. In an attempt to protect the earlier mixer from erosion, some of the surfaces were either hard coated or constructed of heat treated stainless steel which added to the cost of the equipment.

The present invention addresses each of these problems.

One object of the present invention is to provide a straight through design without any internal centrally located recirculation or water jet pipes that that is less inclined to foul and easier to clean than previous designs. Also, this straight design allows the mix chamber of the present invention to be viewed when the connection at the dry powder inlet is broken.

A second object of the present invention is to eliminate the need for a central recirculation line by having more complete coverage in the mixing chamber by employing more annular jets.

An additional object of the present invention is to provide a mixer that employs equal numbers with the recirculation jets and water jets and so that each water jet is located on an opposite side of the mixing chamber from its associated recirculation jet. This feature requires odd numbers of recirculation and water jets and is preferred. Even numbers of these jets is also possible but will not produce the same mixing results.

A further object of the present mixer is to increase the number and capacity of the annular water flow openings that alternate with the annular recirculation openings to thereby allowing greater water flows with less velocity. The path of recirculation and water flows is such that they do not impact the mixer sides and they provide less erosion to the mixer surface than with previous designs. Another object of the present invention is to provide a high performance mixer that has less internal erosion.

A further object of the present invention is to provide a mixer that can be manufactured with lesser expensive materials to thereby reduce the manufacturing cost of the mixer.

Still a further object of the present invention is to provide a mixer that, due to the reduced erosion, will have a longer life and required less maintenance than previous designs. Also disassembly and repair is much simpler with this design.

Another object of the present invention is to provide a smaller, more compact and lighter weight cement mixer.

An additional object of the present invention is to provide a five jet design which allows for more recirculation jets and more water jets than previous designs, resulting in more thorough mixing and better wetting of the cement powder.

An additional object is to have the recirculation jets extending into the dry bulk chamber so as to form a star shape in the bulk inlet chamber which serves to help break up or disperse the incoming dry powder.

These and other objects will become more apparent upon further review of the referenced drawings, detailed description, and claims submitted herewith.

### SUMMARY OF THE INVENTION

The present invention is a cement mixing method and q mixer used in that method for mixing cement that will be used in cementing oil wells casing. The mixer is of the “recirculating” type with variable high pressure water jets. Typically, this type of mixer discharges cement slurry from its outlet end into a diffuser and then into a mixing tank. A recirculation pump is attached to the mixing tank that circulates the already mixed slurry contained in the mixing tank back to recirculation flow inlets provided on the mixer to provide more mixing energy and to provide an opportunity to sample the slurry density. Also typically a mix water pump is connected to a supply of mix water and pumps mix water to a mix water inlet provided on the mixer. The mix water inlet supplies mix water to water jets in the mixer. The water jets control the mixing rate and add mixing energy. Also, bulk cement is added at the dry bulk cement inlet of the mixer. In general, most of the currently used cement slurry mixers have the above characteristics, some doing a better job than others. The present invention is for use in the same type of environment and in association with the same type of equipment as the mixer taught in U.S. Pat. No. 6,749,330 and the teaching regarding associated equipment from that patent is hereby included by reference.

Beginning at the inlet end of the mixer and moving toward the outlet end of the mixer, the mixer is provided at its inlet end with a straight bulk cement inlet for admitting dry powder cement into a mixing chamber that is located internally within the mixer housing.

Adjacent to the dry bulk cement inlet, the mixer is provided with two recirculation flow inlets that both communicate with a recirculation manifold. The recirculation manifold supplies recirculated cement slurry to five annular recirculation jets that are located around the inside of the mixing chamber. For purposes of clarity, the interior of the mixer will be described as being divided into two areas. The first area is the bulk inlet chamber which extends from the inlet to the recirculation jets. The second area is the mixing chamber which extends from the recirculation jets to the outlet of the mixer. Each recirculation jet or outlet is defined by two surfaces within the mixer. One surface is the common wall that separates the bulk inlet chamber from the recirculation jets and the other surface is the common wall that separates the recirculation jets from the mix water manifold. The recirculation outlets discharge at an angle into the mixing chamber.

Adjacent to the recirculation flow inlet, the mixer is provided with a mix water inlet. The mix water inlet communicates with a water manifold that supplies water to five annular water jet orifices provided within the mixing chamber. The mix water manifold is defined by three surfaces within the mixer. One surface is the common wall that separates the recirculation jets from the mix water manifold. A second surface is the outer housing for the mixer, and a third surface is the rotatable orifice plate. Grooves are provided in the surfaces that are adjacent to the rotatable water metering valve element to accommodate pressure face seals to contain water pressure within the mix water manifold. A groove is also provided in the fixed plate for a radial seal to secure the fixed plate to the mixer housing so that fluid does not leak out of the mixing chamber at the junction where the fixed plate is secured to the housing.

As shown in FIG. 3, spacers that are slightly larger in width than the rotatable orifice plate are provided surrounding the rotatable orifice plate to allow the orifice plate sufficient clearance between the wall of the water manifold and the fixed plate so that the orifice plate can be rotated. The mixer is provided with a mix water adjustment input means consisting of a fixed plate containing the annular water jet orifices and rotatable or movable water meter valve element or orifice plate with cut away openings therethrough. The movable orifice plate is located adjacent to the fixed plate and between the water manifold and the fixed plate. The movable orifice plate is provided with a handle for rotating the movable orifice plate relative to the fixed plate.

The fixed plate and the rotatable plate cooperate to control the flow of water through the water jet orifices. The position of the movable orifice plate relative to the fixed plate controls the flow of water through the five annular water jets by more fully aligning the cut away openings of the movable plate with the metering slots of the fixed plate, or alternately, by moving the openings more completely out of alignment with the slots. As the movable orifice plate is rotated in a counter clockwise direction, the cut away openings of the moveable plate move so that they align longitudinally within the mixer more completely with their corresponding annular water jet orifices provided in the fixed plate to allow more water to pass from the water manifold through the openings and slots in the movable and fixed plates and out the annular water jet orifices into the mixing chamber of the mixer. Alternately, when the moveable orifice plate is rotated in a clockwise direction, the cut away openings of the moveable plate move out of alignment longitudinally within the mixer with their corresponding annular water jet orifices provided in the fixed plate to allow less water to pass from the water manifold through the movable and fixed plates and out the annular water jet orifices into the mixing chamber of the mixer.

The water jet orifices are angled in orientation so that their discharge is directed inwardly towards the mixing chamber. All of the existing technology with annular adjustable orifices is aligned in an axial direction. These axial designs require the flow direction to be “turned” or deflected beyond the jet to hit the desired mixing chamber location. The turning of high velocity flow causes high wear on mixer parts.

Also, the water jets are located downstream of the recirculation jets. This allows for more compact construction, much lower production cost, and easier maintenance.

The five annular recirculation jets are located in alternating longitudinal alignment within the mixing chamber relative to the five annular water jet so that they alternate with and are evenly spaced relative to the annular flow recirculation outlets. The five jet design allows for more recirculation jets and more water jets than previous designs, resulting in more thorough mixing (better wetting of powder).

The mixer employs equal numbers of recirculation jets and water jets and so that each water jet is located on an opposite side of the mixing chamber from its associated recirculation jet. Although odd numbers of recirculation and water jets is preferred, even numbers of these jets are also possible.

The evenly spaced water jets deliver mix water annularly to the mixing chamber and alternate with the recirculation jets which also deliver recirculation flow annularly to the mixing chamber. This arrangement is important for several reasons. The location of the water jets is such that they oppose or intersect each of the recirculation flow jets when odd numbers of water jets and recirculation jets are employed, thus enhancing mixing. Existing technology with annular adjustable orifices alternate rather than intersect the discharge from the recirculation jet flow. Also, the arrangement is important as it puts the flow from each water jet on the opposite side of the mixing chamber from the flow from one of the recirculation jets. This aides in mixing and also tends to protect the internal surfaces of the mixing chamber from abrasion by the sand and grit contained in the recirculated cement slurry flowing out of the recirculation jets or by sand contained in unclean water flowing out of the water jets when the water source is unclean.

Finally, an outlet for the mixer is provided at the outlet end of the mixer. The mixture of cement leaves the mixing chamber of the mixer through the outlet.

### BRIEF DESCRIPTION OF THE DRAWINGS

FIG. 1 is an inlet end view of a cement mixer constructed according to a preferred embodiment of the present invention.

FIG. 2 is a right side view of the cement mixer of FIG. 1.

FIG. 3 is a cross sectional view taken along line 3-3 of FIG. 1.

FIG. 4 is a cross sectional view taken along line 4-4 of FIG. 3 showing the mix water manifold and the star like appearance of the recirculation jets when viewed from this perspective.

FIG. 5 is a cross sectional view taken along line 5-5 of FIG. 3 showing the rotatable orifice plate.

### DETAILED DESCRIPTION OF THE PREFERRED EMBODIMENT

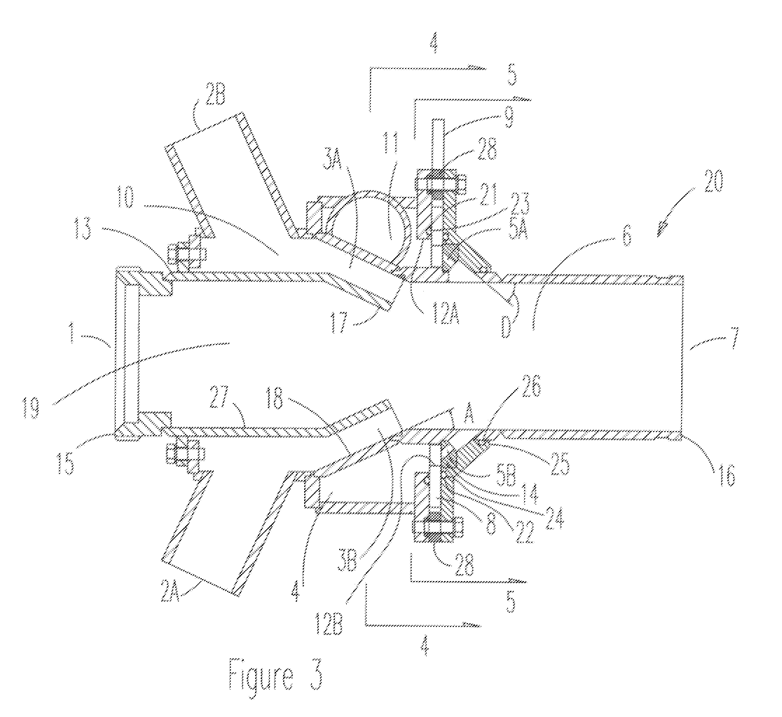

Referring now to the drawings and initially to FIGS. 2 and 3, the present invention is a cement mixing method and the mixer 20 used in that method for mixing cement that will be used in cementing oil wells. The overall typical system and equipment within which the mixer 20 is likely to be used are taught in U.S. Pat. No. 6,749,330. That teaching is incorporated herein by reference.

As explained in detail in U.S. Pat. 6,749,330, typically a cement mixer discharges from its outlet end into a diffuser and subsequently into a mixing tank.

A recirculation pump is attached to the mixing tank and recirculates the contents of the mixing tank to recirculation flow inlets provided on the mixer. And, typically a mix water pump is connected to a supply of mix water and pumps that mix water to a mix water inlet provided on the mixer. Also, bulk cement is pneumatically delivered to the dry bulk cement inlet of the mixer. It is the cement mixer 20 that is the subject of the present invention. A preferred embodiment of the invention is shown in the attached drawings and will be more fully described hereafter.

Referring to FIG. 3, the mixer 20 is shown in cross sectional view. For purposes of clarity, the interior of the mixer 20 will be described as being divided into two areas. The first area is the bulk inlet chamber 19 which extends from the inlet 1 to the recirculation jets 3A, 3B, 3C, 3D and 3E. The bulk inlet chamber 19 receives the dry powder cement from the inlet 1 and conveys it to the second area which is the mixing chamber 6. No mixing occurs in the bulk inlet chamber 19. The mixing chamber 6 extends from the recirculation jets 3A, 3B, 3C, 3D and 3E to the outlet 7 of the mixer 20 and it is in the mixing chamber where the cement powder is mixed with the recirculated slurry and mix water. The mixer 20 is provided at its inlet end 15 with a straight bulk cement inlet 1 for admitting dry powder cement into a bulk inlet chamber 19 located internally within the mixer housing 13 and then into a mixing chamber 6 which is also located internally within the mixer housing 13. Adjacent to the dry bulk cement inlet 1 are two recirculation flow inlets 2A and 2B that both communicate with a recirculation manifold 10 that supplies recirculated cement slurry to five annular recirculation jets 3A, 3B, 3C, 3D and 3E located around the inside of the mixing chamber 6. Adjacent to the recirculation flow inlets 2A and 2B is a mix water inlet 11 that communicates with a mix water manifold 4 that supplies water to five annular water jets or jet orifices 5A, 5B, 5C, 5D and 5E provided within the mixing chamber 6 in alternating longitudinal alignment within the mixing chamber 6 relative to the five annular recirculation jets 3A, 3B, 3C, 3D and 3E so that they alternate with and are evenly spaced relative to the recirculation jets 3A, 3B, 3C, 3D and 3E.

The water manifold 4 has a mix water adjustment output means consist of a fixed plate 14 containing the annular water jet orifices 5A, 5B, 5C, 5D and 5E and a rotatable or movable water meter valve element or orifice plate 8 with cut away openings 12A, 12B, 12C, 12D and 12E therethrough. The movable orifice plate 8 is provided with a handle 9 for rotating it in order to control the flow of mix water passing through the five annular water jets 5A, 5B, 5C, 5D and 5E. At an outlet end 16 of the mixer 20 is an outlet 7 that discharges the cement mixture from the mixing chamber 6 of the mixer 20. The details of all of these features will be described in more detail hereafter beginning at the inlet end 15 of the mixer 20 and moving toward the opposite outlet end 16 of the mixer 20.

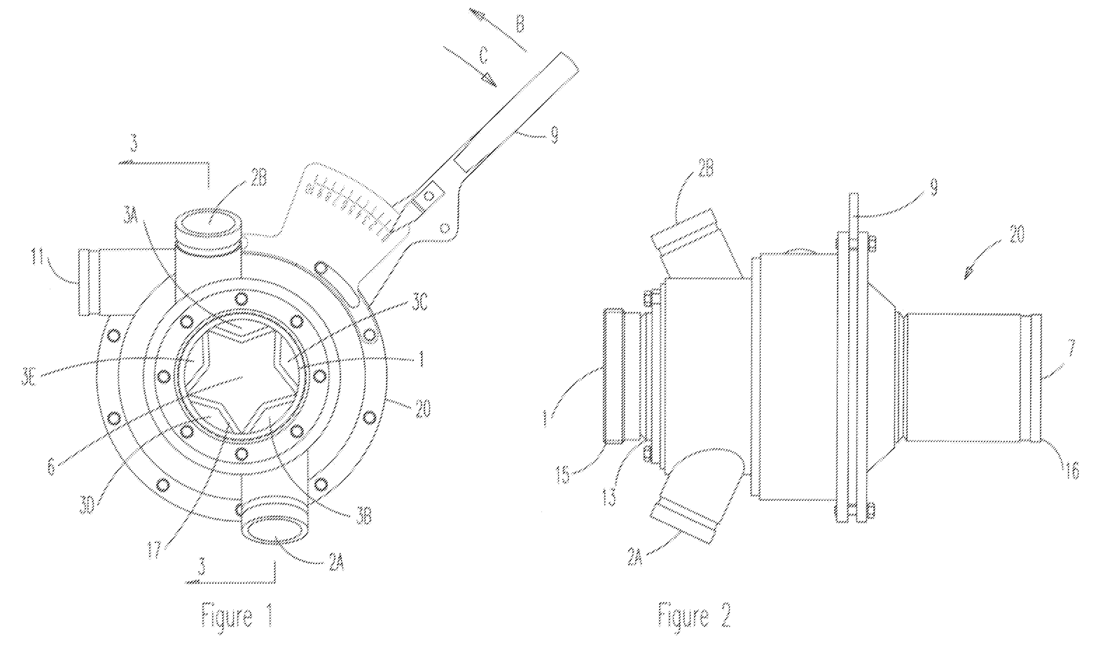

Beginning at the inlet end 15 of the mixer 20, the mixer 20 is provided with a straight bulk cement inlet 1 for admitting dry powder cement into the mixing chamber 6 that is located internally within the mixer housing 13. The straight bulk cement inlet 1 permits an unobstructed view inside and through both the bulk inlet chamber 19 and the mixing chamber 6 of the mixer 20 when piping that is normally connected with the inlet is disconnected therefrom, as best illustrated in FIG. 1. Also, this straight design allows for easier cleaning and inspection of both the bulk inlet chamber 19 and the mixing chamber 6.

Referring now to FIGS. 2 and 3, adjacent the dry bulk cement inlet 1, the mixer 20 is provided with the two recirculation flow inlets 2A and 2B that both communicate with the recirculation manifold 10. The recirculation manifold 10 supplies recirculated cement slurry to five annular recirculation jets 3A, 3B, 3C, 3D and 3E that are located around the inside of the mixing chamber 6. Each recirculation jet or outlet 3A, 3B, 3C, 3D and 3E is defined by two surfaces 17 and 18 within the mixer 20. The first surface is the common wall 17 that separates the bulk inlet chamber 19 from the recirculation jets 3A, 3B, 3C, 3D and 3E, and the second surface is the common wall 18 that separates the recirculation jets 3A, 3B, 3C, 3D and 3E from the mix water manifold 4. The recirculation jets 3A, 3B, 3C, 3D and 3E discharge at an angle A into the mixing chamber 6.

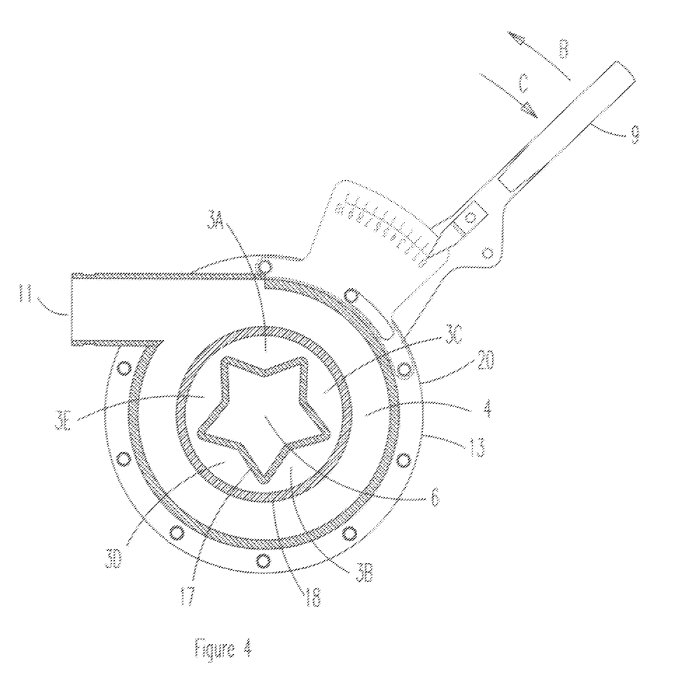

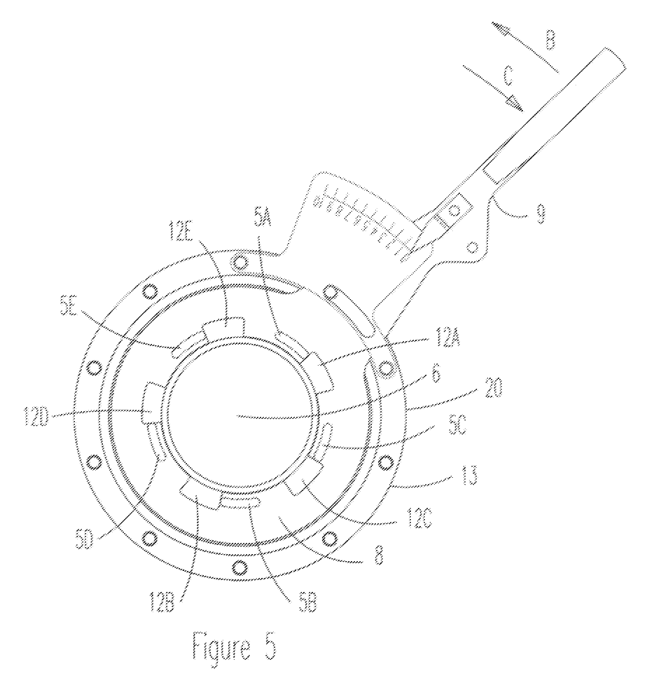

Referring to FIG. 3 and 4, adjacent to the recirculation flow inlets 2A and 2B, the mixer 20 is provided with the mix water tangential inlet 11. It is important that the inlet 11 be tangential relative to the water manifold 4 as water is then supplies tangentially. By supplying the mix water tangentially, this supplies the water so that it approaches the metering openings and metering slots 12A-E and 5A-E and in a uniform manner, i.e. in the same direction, thus creating equal flow characteristics therethrough for all metering openings and metering slots 12A-E and 5A-E.

The mix water inlet 11 communicates with the water manifold 4 that supplies water to five annular water jet orifices 5A, 5B, 5C, 5D and 5E provided within the mixing chamber 6.

Referring to FIGS. 3 and 5, the mix water manifold 4 is defined by three surfaces 18, 13 and 8 within the mixer 20. The first surface is the common wall 18 that separates the recirculation jets 3A, 3B, 3C, 3D and 3E from the mix water manifold 4. The second surface is the outer mixer housing 13 for the mixer 20, and the third surface is the rotatable orifice plate 8. Grooves 21 and 22 are provided in the surfaces that are adjacent to the rotatable water metering valve element 8 to accommodate pressure face seals 23 and 24 to contain water pressure within the mix water manifold 4. A groove 25 is also provided in the fixed plate 14 for a radial seal 26 to seal the fixed plate 14 to the housing 13 of the mixer 20 so that fluid does not leak out of the mixing chamber 6 between the fixed plate 14 and the housing 13.

As shown in FIGS. 3 and 5, the mixer 20 is provided with a mix water adjustment input means consist of the fixed plate 14 which contains the annular water jet orifices 5A, 5B, 5C, 5D and 5E and the rotatable or movable water meter valve element or orifice plate 8 with cut away openings 12A, 12B, 12C, 12D and 12E therethrough. The movable orifice plate 8 is located adjacent to the fixed plate 14 and between the water manifold 4 and the fixed plate 14. As shown in FIG. 3, spacers 28 that are slightly larger in width than the rotatable orifice plate 8 are provided surrounding the rotatable orifice plate 8 to allow the orifice plate 8 sufficient clearance between the wall of the water manifold 4 and the fixed plate 14 so that the orifice plate 8 can be rotated. The movable orifice plate 8 is provided with a handle 9 for rotating the movable orifice plate 8 relative to the fixed plate 14.

The fixed plate 14 and the rotatable plate 9 cooperate to control the flow of water through the water jet orifices 5A, 5B, 5C, 5D and 5E. The position of the movable orifice plate 8 relative to the fixed plate 14 controls the flow of water through the five annular water jets 5A, 5B, 5C, 5D and 5E by more fully aligning the cut away openings 12A, 12B, 12C, 12D and 12E of the movable plate 8 with the metering slots 5A, 5B, 5C, 5D and 5E of the fixed plate 14, or alternately, by moving the cut away openings 12A, 12B, 12C, 12D and 12E more completely out of alignment with the slots 5A, 5B, 5C, 5D and 5E. As the movable orifice plate 8 is rotated in a counter clockwise direction, as indicated by Arrow B in FIG. 4, the cut away openings 12A, 12B, 12C, 12D and 12E of the moveable plate 8 move so that they align longitudinally within the mixer 20 more completely with their corresponding annular water jet orifices 5A, 5B, 5C, 5D and 5E provided in the fixed plate 14. This allows more water to pass from the water manifold 4 through the aligned portions of the openings 12A, 12B, 12C, 12D and 12E and slots 5A, 5B, 5C, 5D and 5E and into the mixing chamber 6. Alternately, when the moveable orifice plate 8 is rotated in a clockwise direction, as indicated by Arrow C in FIG. 4, the cut away openings 12A, 12B, 12C, 12D and 12E of the moveable plate 8 move more out of alignment longitudinally within the mixer 20 with their corresponding annular water jet orifices 5A, 5B, 5C, 5D and 5E. This allows less water to pass from the water manifold 4 through the movable and fixed plates 8 and 14 and out into the mixing chamber 6. The water jets 5A, 5B, 5C, 5D and 5E discharge at an angle D into the mixing chamber 6.

The five annular recirculation jets 3A, 3B, 3C, 3D and 3E are located in alternating longitudinal alignment within the mixing chamber 6 relative to the five annular water jet 5A, 5B, 5C, 5D and 5E so that they alternate with and are evenly spaced relative to the water jets 5A, 5B, 5C, 5D and 5E. The evenly spaced and alternating water jets 5A, 5B, 5C, 5D and 5E deliver mix water annularly to the mixing chamber 6 and the recirculation jets 3A, 3B, 3C, 3D and 3E also deliver recirculation flow annularly to the mixing chamber 6. This arrangement is important as it puts the flow from each water jet 5A, 5B, 5C, 5D and 5E on the opposite side of the mixing chamber 6 from the flow from one of the recirculation jets 3A, 3B, 3C, 3D and 3E. This aides in mixing and also tends to protect the internal surfaces of the mixing chamber 8 from abrasion by the sand and grit contained in the recirculated cement slurry flowing out of the recirculation jets 3A, 3B, 3C, 3D and 3E and sand from dirty water flowing out of the water jets 5A, 5B, 5C, 5D, and 5E when a dirty water source is employed.

Referring to FIGS. 1 and 4, the five recirculation jets 3A, 3B, 3C, 3D and 3E are arranged in such a way as to create a “star” arrangement in the inner casing 17 which is the common wall between the bulk inlet chamber 196 and the five recirculation jets 3A, 3B, 3C, 3D and 3E. By having the inner casing 17 in a “star” arrangement and extending inside and inwardly beyond the normal parallel walled casing ID, as indicated by numeral 27 in the drawings, this helps to reshape the configuration of the dry bulk powder into a “star” shape as it flows through the bulk inlet chamber 19 and enters the mixing chamber 6 before it is hit with flow from the recirculation jets 3A, 3B, 3C, 3D and 3E. The resulting “star” shape of the flow of powder tends to assist in splitting up or break up the flow of dry bulk cement coming through the casing ID, thus enhancing the wetability of the bulk cement.

Finally, as shown in FIGS. 2 and 3, the outlet 7 for the mixer 20 is provided at the outlet end 16 of the mixer 20. The mixture of cement leaves the mixing chamber 6 of the mixer 20 through the outlet 7.

Although the invention has been described as having five recirculation jets 3A, 3B, 3C, 3D and 3E and five water jets 5A, 5B, 5C, 5D and 5E, the invention is not so limited. In fact the invention can be provided with only three recirculation jets and only three water jets, or alternately, with seven of each. The important thing is that each water jet is located on an opposite side of the mixing chamber 6 from an associated recirculation jets so that the flow from the water jet intersects with the flow from its associated recirculation jet. The preferred arrangement is where there is the same number of recirculation jets as water jets and where there are odd numbers of each type of jets, i.e. three, five, seven, etc. of each of the recirculation jets and water jets. For example, a smaller mixer might employ only three recirculation jets and three water jets, while a larger mixer might employ seven recirculation jets and seven water jets.

### Operation

Dry bulk cement powder is pneumatically blown straight into the mixer 20 at straight dry bulk cement inlet 1. As the dry bulk cement passes through the mixer's internal mixing chamber 6, it is intercepted by flow of recirculated cement slurry flowing from the five recirculation jets 3A, 3B, 3C, 3D and 3E. The interception of the dry bulk cement by the recirculated slurry is the first step in wetting the cement powder. A short distance later (milliseconds in time) and downstream within the mixing chamber 6, the five water jets 5A, 5B, 5C, 5D and 5E intersect the partially wetted cement. The mixing energy imparted by the recirculation jets 3A, 3B, 3C, 3D and 3E and the water jets 5A, 5B, 5C, 5D and 5E is very high. The high energy of all ten jets, i.e. five recirculation jets 3A, 3B, 3C, 3D and 3E and five water jets 5A, 5B, 5C, 5D and 5E, creates well mixed slurry where all particles are wetted. The recirculation rate is constant and typically 20 bbl/min. The water flow is adjusted by rotating the orifice plate 8. FIG. 4 shows the orifice plate 8 with the cut away openings 12A, 12B, 12C, 12D and 12E and metering slots 5A, 5B, 5C, 5D and 5E. As the orifice plate 8 is moved counter clockwise, i.e. in the direction indicated by Arrow B, the metering slots 5A, 5B, 5C, 5D and 5E are uncovered so that liquid flows therethrough. The flow rate is approximately proportional to the rotation of the orifice plate 8. Typical pressure is 125 psi and maximum flow might be in the range of 10 bbl/min. The thoroughly wetted and mixed cement slurry exits the mixing chamber 13 via the outlet 7 and flows to the mixing tank, as previously described above for a typical equipment arrangement.

Although the invention has been described for use in mixing cement for oil or gas wells, the invention is not so limited and can be used to mix a variety of bulk powders into a solution. Also, the usage of this invention is not limited to the oil and gas industry, but could be used in other industries where dry bulk powders must be mixed into a solution, such as for example the food preparation industry.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A powder mixer for mixing a dry powder with liquid comprising:
a powder mixer having a dry bulk powder inlet provided at one end of the mixer, said inlet communicating with a mixing chamber provided within the powder mixer, said mixing chamber communicating with an outlet provided at an opposite end of the mixer,
recirculation jets provided annularly within said mixing chamber,
water jets provided annularly within said mixing chamber downstream of the recirculation jets.

2. A powder mixer for mixing a dry powder with liquid comprising:
a powder mixer having a dry bulk powder inlet provided at one end of the mixer, said inlet communicating with a mixing chamber provided within the powder mixer, said mixing chamber communicating with an outlet provided at an opposite end of the mixer,
recirculation jets provided annularly within said mixing chamber,
water jets provided annularly within said mixing chamber, said water jets directed inwardly within said mixing chamber.

3. A powder mixer for mixing a dry powder with liquid according to claim 2 further wherein said water jets are provided downstream of the recirculation jets,
a water manifold attached to and supplying water to said water jets, and
a tangential water inlet attached to and supplying water to said water manifold.

4. A powder mixer for mixing a dry powder with liquid according to claim 1 further comprising:
said recirculation jets extending into the mixing chamber to form a “star” configuration in the mixing chamber.

5. A powder mixer for mixing a dry powder with liquid according to claim 4 wherein each water jet is associated with a recirculation jet, said recirculation jets and said water jets are of an odd number each, and each water jet is provided on an opposite side of the mixing chamber from its associated recirculation jet.

6. A powder mixer for mixing a dry powder with liquid comprising:
a powder mixer having a dry bulk powder inlet provided at one end of the mixer, said inlet communicating with a mixing chamber provided within the powder mixer, said mixing chamber communicating with an outlet provided at an opposite end of the mixer,
recirculation jets provided annularly within said mixing chamber and extending into the mixing chamber to form a “star” configuration in the mixing chamber,
water jets provided annularly within said mixing chamber, and said water jets directed inwardly within said mixing chamber.

7. A powder mixer for mixing a dry powder with liquid according to claim 6 wherein each water jet is associated with a recirculation jet, said recirculation jets and said water jets are of an odd number each, and each water jet is provided on an opposite side of the mixing chamber from its associated recirculation jet.

8. A powder mixer for mixing a dry powder with liquid according to claim 6 wherein said water jets are provided downstream of the recirculation jets.

9. A powder mixer for mixing a dry powder with liquid according to claim 8 wherein each water jet is associated with a recirculation jet, said recirculation jets and said water jets are of an odd number each, and each water jet is provided on an opposite side of the mixing chamber from its associated recirculation jet.

10. A powder mixer for mixing a dry powder with liquid according to claim 1 further comprising:
Said inlet being straight so that it forms a straight path into said mixing chamber, and
said recirculation jets forming a “star” shaped configuration where the recirculation jets extend into the mixing chamber.

11. A powder mixer according to claim 10 wherein said recirculation jets converge inwardly within the mixing chamber to intersect the dry bulk powder entering through the inlet and thoroughly wetting and mixing with any dry bulk powder that is introduced into the mixing chamber.

12. A powder mixer according to claim 10 wherein at least three recirculation jets are provided annularly within said mixing chamber.

13. A powder mixer according to claim 10 further comprising:
adjustable water jets provided annularly within said mixing chamber, said water jets arranged in alternating longitudinal alignment within the mixing chamber relative to the recirculation jets so that they alternate with and are evenly spaced relative to the recirculation jets in a manner where the flow of mix water from the water jets intersects with the flow of recirculated wetted powder mixture from the recirculation jets.

14. A powder mixer according to claim 13 wherein said adjustable water jets converge inwardly so that flow of mix water from said adjustable water jets converge inwardly within the mixing chamber to intersect flow from the recirculation jets in the mixing chamber to mix with and wet any dry bulk powder introduced into the mixing chamber.

15. A powder mixer according to claim 13 wherein at least three at least three adjustable water jets are provided annularly within said mixing chamber.

16. A powder mixer according to claim 13 further comprising:
a rotating orifice plate provided within said mixer and rotatable by means of an attached handle, said rotating orifice plate provided with cut away openings therethrough, and
a fixed plate provided in said mixer, said fixed plate provided with jet openings therethrough so that the cut away openings provided in the rotating orifice plate and the jet openings provided in the fixed plate cooperate to adjust the flow from the adjustable water jets.

17. A powder mixing method for mixing powder for use in high volume mixing applications comprising:
introducing recirculated wetted powder mixture annularly into a mixing chamber of a powder mixer via recirculation jets provided annularly in said mixer so that the flow of recirculated wetted powder mixture from the recirculation jets enters the mixing chamber at an angle,
introducing a regulated amount of mix water into said mixing chamber annularly downstream of and in alternating arrangement with said recirculation jets via adjustable water jet provided annularly in said mixer so that the flow of mix water from the water jets enters the mixing chamber at an angle and intersects with the flow of recirculated wetted powder mixture from the recirculation jets, and
introducing dry bulk powder centrally into said mixing chamber from upstream of said recirculation outlets via a straight bulk powder inlet provided in said mixing chamber so that the mix water and recirculated wetted powder mixture intersect with and thoroughly wet and mix with the dry bulk powder.

18. A powder mixing method according to claim 17 further comprising:
regulating the amount of mix water introduced into said mixing chamber by rotating a rotating orifice plate provided within said mixer by means of an attached handle so that cut away openings provided in said rotating orifice plate cooperate with water jet orifices provided in a fixed part of said mixer to adjust the flow of mix water entering the mixing chamber via the water jets.

19. A powder mixing method according to claim 17 wherein flow of wetted powder mixture from the annular recirculation jets is introduced into the mixing chamber so that it converges inwardly within the mixing chamber to thoroughly wet and mix with any dry bulk powder that is introduced into the mixing chamber.

20. A powder mixing method according to claim 18 wherein flow of mix water from the adjustable water jet is introduced into the mixing chamber so that it converges inwardly within the mixing chamber to thoroughly wet and mix with any dry bulk powder introduced into the mixing chamber.

21. A powder mixer for mixing a dry powder with liquid comprising:
a powder mixer having a dry bulk powder inlet provided at one end of the mixer, said inlet communicating with a mixing chamber provided within the powder mixer, said mixing chamber communicating with an outlet provided at an opposite end of the mixer,
water jets provided annularly within said mixing chamber and said water jets directed inwardly within said mixing chamber.

22. A powder mixer for mixing a dry powder with liquid according to claim 21 further comprising:
said water jets being adjustable.

23. A powder mixer for mixing a dry powder with a liquid according to claim 22 wherein the water jets are adjustable by rotating a movable orifice plate provided on the mixer relative to a fixed plate provided adjacent to the movable orifice plate on the mixer.

24. A powder mixer for mixing a dry powder with liquid according to claim 21 further comprising:
at least one recirculation jet provided discharging recirculated fluid into the said mixing chamber.

25. A powder mixer for mixing a dry powder with liquid according to claim 24 wherein said water jets are adjustable.
